(19) United States
(12) Patent Application Publication
(10) Pub. No.: US 2016/0378816 A1
(43) Pub. Date: Dec. 29, 2016

(54) SYSTEM AND METHOD OF VERIFYING PROVISIONED VIRTUAL SERVICES

(71) Applicants: Sergio Colla, San Jose, CA (US); Nihal Singh, San Jose, CA (US); Bill Leung, San Jose, CA (US); Sakthikumar Balakrishnan, Sunnyvale, CA (US); Srinivasan Boovaraghavan, Sunnyvale, CA (US)

(72) Inventors: Sergio Colla, San Jose, CA (US); Nihal Singh, San Jose, CA (US); Bill Leung, San Jose, CA (US); Sakthikumar Balakrishnan, Sunnyvale, CA (US); Srinivasan Boovaraghavan, Sunnyvale, CA (US)

(73) Assignee: ALCATEL-LUCENT USA INC., Murray Hill, NJ (US)

(21) Appl. No.: 14/747,950

(22) Filed: Jun. 23, 2015

(51) Int. Cl. G06F 17/30; H04L 29/08

(52) U.S. Cl. CPC G06F 17/30371; H04L 67/1097; G06F 17/30292

(57) ABSTRACT

This disclosure relates to various systems, methods, architectures, mechanisms, or apparatuses for verifying or auditing that virtual services are correctly instantiated at a data center. Verification that virtual services are correctly instantiated at a data center may include comparing normalized datasets representing the actual instantiated services associated with a virtual services provisioning entity to normalized datasets representing the expected instantiated services associated with the provisioning entity. Verification that virtual services are correctly instantiated at a data center may include monitoring one or more communication channels of a virtual services control entity to identify a provisioning command intended for the provisioning entity, determining whether the identified provisioning command intended for the provisioning entity has been received by the provisioning entity, and generating an alert based on a determination that the identified provisioning command intended for the provisioning entity has not been received by the provisioning entity.

### TECHNICAL FIELD

The disclosure relates generally to the field of network and data center management and, more particularly but not exclusively, to management of virtual network elements and services in networks, data centers, and the like.

### BACKGROUND

Within the context of a typical data center (DC) arrangement, a tenant entity, such as a bank or other entity, has provisioned for it a number of virtual machines (VMs) which may be accessed via a Wide Area Network (WAN) using the Border Gateway Protocol (BGP). At the same time, thousands of other VMs may be provisioned for hundreds or thousands of other tenants. The scale associated with a DC may be enormous; for example, thousands of VMs may be created or destroyed each day per tenant demand. Moreover, the number of virtual services provisioning entities within large DCs is increasing as well. Further, these provisioning entities may themselves be virtual or non-virtual. Further, given the hierarchical relationship among many virtual services, virtual and non-virtual provisioning entities, and so on, failures or errors may cascade through multiple virtual and non-virtual services within a DC.

### SUMMARY

Various deficiencies in the prior art are addressed by systems, methods, architectures, mechanisms, or apparatuses for verifying that virtual services are correctly instantiated inside or outside of a data center. Verification that virtual services are correctly instantiated at a data center may include comparing normalized datasets representing the actual instantiated services associated with a virtual services provisioning entity to normalized datasets representing the expected instantiated services associated with the provisioning entity. Verification that virtual services are correctly instantiated at a data center may include monitoring one or more communication channels of a virtual services control entity to identify a provisioning command intended for the provisioning entity, determining whether the identified provisioning command intended for the provisioning entity has been received by the provisioning entity, and generating an alert based on a determination that the identified provisioning command intended for the provisioning entity has not been received by the provisioning entity.

### BRIEF DESCRIPTION OF THE DRAWINGS

The teachings herein can be readily understood by considering the following detailed description in conjunction with the accompanying drawings, in which:

FIG. 1 depicts a high-level block diagram of a system benefiting from various embodiments;

FIG. 2 depicts a simplified representation of a Virtual Services Platform (VSP) suitable for use within the system of FIG. 1;

FIG. 3 depicts an exemplary management system suitable for use within the system of FIG. 1;

FIG. 4 depicts a flow diagram of an instantiated services verification method according to various embodiments;

FIG. 5 depicts a flow diagram of an instantiated services verification method according to various embodiments;

FIG. 6 depicts a flow diagram of an instantiated services verification method according to various embodiments;

FIG. 7 depicts raw data useful in understanding various embodiments;

FIG. 8 depicts a normalized version of the raw data of FIG. 7 that has been normalized in a tabular format;

FIGS. 9A and 9B depict a normalized version of the raw data of FIG. 7 that has been normalized in an XML format;

FIGS. 10A and 10B depict a normalized version of the raw data of FIG. 7 that has been normalized in a JSON format; and

FIG. 11 depicts a high-level block diagram of a computing device suitable for use in performing the functions described herein.

To facilitate understanding, identical reference numerals have been used, where possible, to designate identical elements that are common to the figures.

### DETAILED DESCRIPTION

Various embodiments will be primarily described within the context of systems, methods, architectures, mechanisms, or apparatuses adapted for use in network and data center (DC) management including management of virtual network elements and services in networks, DCs, and the like. However, those skilled in the art and informed by the teachings herein will realize that various embodiments presented herein also may be applicable to various other technical areas.

Various embodiments will be described within the context of sophisticated DC architectures which may use virtualized and non-virtualized control, management, and/or network service elements. For example, Nuage Networks, of Mountain View, Calif., uses Software Defined Networking (SDN) to provide Virtualized Network Services (VNS) solutions in which various control elements, provisioning elements, routing/switching elements, and the like may be implemented as virtualized or non-virtualized entities.

Various embodiments provide mechanisms for rapidly and proactively providing auditing, verification, and/or other functions adapted to identify provisioning errors or potential provisioning errors. These embodiments may be flexibly implemented within the context of different entities within a DC, such as via management system entities, virtualized or non-virtualized control entities, virtualized or non-virtualized provisioning entities, and so on. Moreover, various embodiments contemplate that processing of datasets and the like related to virtual provisioning may be performed at some or all of these entities.

Various embodiments provide an auditing or verification function wherein the actual instantiated services associated with a provisioning entity are compared to the expected instantiated services associated with that provision entity by comparing normalized datasets representing the actual and expected instantiated services. The auditing or verification function may be performed periodically, in response to a user or customer verification request, in response to a detection of an error associated with one or more relevant control entities, or the like, as well as various combinations thereof.

Various embodiments provide a product or mechanism wherein a monitoring agent instantiated at a virtual services provisioning entity monitors a data bus supporting communications between other control entities to identify virtual service provisioning commands relevant to the provisioning entity and, where commands relevant to the provisioning entity indicate that the provisioning entity should expect to receive a virtual service provisioning command, the failure of the provisioning entity to receive that virtual service provisioning command according to a predetermined criteria (e.g., within a predetermined time frame or according to other criteria) will result in an alert (e.g., a warning, an alarm, an error message, or the like) adapted to trigger investigation of the failure of the provisioning entity to receive that virtual service provisioning command according to the predetermined criteria.

It is noted that the description and drawings merely illustrate various principles of various embodiments. It will thus be appreciated that those skilled in the art will be able to devise various arrangements that, although not explicitly described or depicted herein, embody the principles of the various embodiments and are included within its scope. Furthermore, various examples recited herein are principally intended expressly to be only for pedagogical purposes to aid the reader in understanding the principles of the various embodiments and the concepts contributed to furthering the art, and are to be construed as being without limitation to such specifically recited examples and conditions. Additionally, the term, “or,” as used herein, refers to a non-exclusive or, unless otherwise indicated (e.g., use of “or else” or “or in the alternative”). Also, the various embodiments described herein are not necessarily mutually exclusive, as some embodiments can be combined with one or more other embodiments to form new embodiments.

DC architecture generally includes a large number of computing and storage resources that are interconnected through a scalable Layer 2 (L2) or Layer 3 (L3) infrastructure. In addition to this networking infrastructure running on hardware devices, the DC architecture includes software networking components (e.g., virtual switches) running on general purpose computers, and dedicated hardware appliances that supply specific network services, such as load balancers (LBs), ADCs, firewalls, Intrusion Prevention Systems (IPSs) and/or Intrusion Defense Systems (IDSs), or the like. The DC infrastructure can be owned by an enterprise or by a service provider (which may be referred to as a Cloud Service Provider (CSP)), and shared by a number of tenants. Computing and storage infrastructure are virtualized in order to allow different tenants to share the same resources. Each tenant can dynamically add/remove resources from the global pool to/from its individual service.

Virtual services as discussed herein may generally include any type of virtualized computing or storage resources capable of being provided to a tenant. Moreover, virtual services also may include access to non-virtual appliances or other devices using virtualized computing/storage resources, DC network infrastructure, and so on. The various embodiments are adapted to improve event-related processing within the context of DCs, networks, and the like.

Generally speaking, various embodiments enable, support, or improve provisioning and monitoring associated with building a virtual infrastructure layer (e.g., virtual machines (VMs), virtual switches, virtual L2/L3 services, and the like) on top of a provisioned transport layer within a DC including various network entities/resources. Various embodiments may be extended to include other network elements/resources outside of the DC.

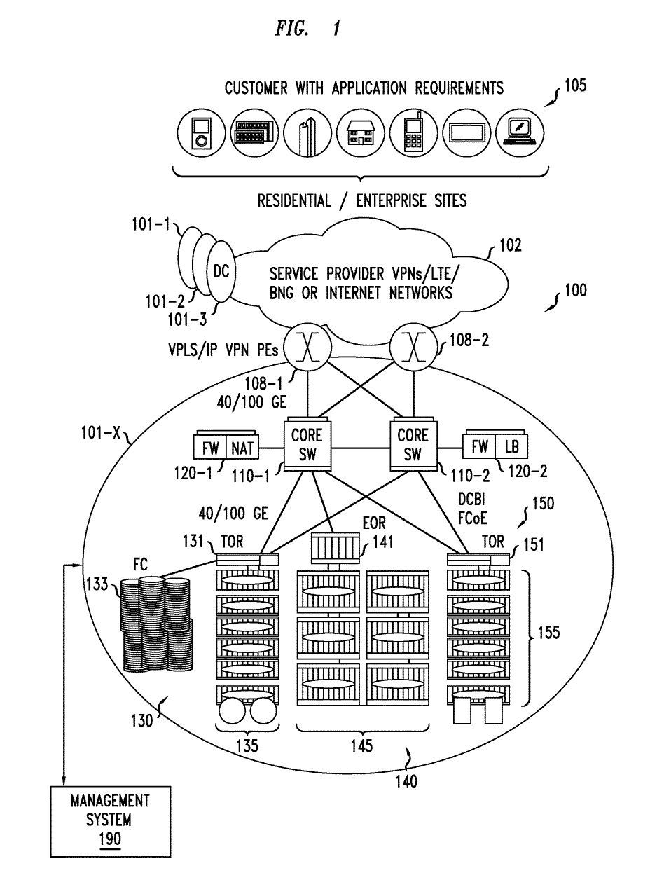

FIG. 1 depicts a high-level block diagram of a system benefiting from various embodiments.

Specifically, FIG. 1 depicts a system 100 comprising a plurality of data centers (DCs) 101-1 through 101-X (collectively, DCs 101) operative to provide computing and storage resources to numerous customers having application requirements at residential or enterprise sites 105 via one or more networks 102.

The customers having application requirements at residential or enterprise sites 105 interact with the one or more networks 102 via any standard wireless or wireline access networks to enable local client devices (e.g., computers, mobile devices, set-top boxes (STBs), storage area network (SAN) components, Customer Edge (CE) routers, access points, and the like) to access virtualized computing and storage resources at one or more of the DCs 101.

The networks 102 may include any of a plurality of available access network or core network topologies and protocols, alone or in any combination, such as Virtual Private Networks (VPNs), Long Term Evolution (LTE), Border Network Gateway (BNG), Internet networks, and the like.

The various embodiments will generally be described within the context of Internet Protocol (IP) networks enabling communication between provider edge (PE) nodes 108. Each of the PE nodes 108 may support multiple DCs 101. That is, the two PE nodes 108-1 and 108-2 depicted in FIG. 1 as communicating between networks 102 and DC 101-X may also be used to support a plurality of other DCs 101.

The DC 101-X is depicted as including a plurality of core switches 110-1 and 110-2 (collectively, core switches 110), a plurality of service appliances 120-1 and 120-2 (collectively, service appliances 120), a first resource cluster 130, a second resource cluster 140, and a third resource cluster 150.

The two PE nodes 108-1 and 108-2 are connected to each of the two core switches 110-1 and 110-2. More or fewer PE nodes 108 or core switches 110 may be used (and it is noted that redundant or backup capability is typically desired). The PE routers 108 interconnect the DC 101-X with the networks 102 and, thereby, other DCs 101 and customers having application requirements at residential or enterprise sites 105. The DC 101 is generally organized in cells, where each cell can support thousands of servers and VMs.

The core switches 110-1 and 110-2 are associated with service appliances 120-1 and 120-2, respectively. The service appliances 120 may be used to provide higher layer networking functions, such as providing firewalls (FWs), performing load balancing (LB) functions, performing network address translation (NAT) functions, or the like.

The resource clusters 130-150 are depicted as computing or storage resources organized as racks of servers implemented either by multi-server blade chassis or individual servers. In general, each rack holds a number of servers (depending on the architecture), and each server can support a number of processors. A set of network connections connect the servers with either a Top-of-Rack (ToR) switch or an End-of-Rack (EoR) switch. It will be appreciated that, while only three resource clusters 130-150 are shown herein, hundreds or thousands of resource clusters may be used. Moreover, the configuration of the depicted resource clusters 130-150 is for illustrative purposes only; many more and varied resource cluster configurations are known to those skilled in the art. In addition, specific (e.g., non-clustered) resources may also be used to provide computing or storage resources within DC 101-X.

The three resource clusters 130-150 are depicted as including specific switches and other devices/elements, respectively. For example, exemplary resource cluster 130 is depicted as including a ToR switch 131 in communication with a mass storage device(s) or storage area network (SAN) 133, as well as a plurality of server blades 135 adapted to support, illustratively, VMs. For example, exemplary resource cluster 140 is depicted as including an EoR switch 141 in communication with a plurality of discrete servers 145. For example, exemplary resource cluster 150 is depicted as including a ToR switch 151 in communication with a plurality of virtual switches 155 adapted to support, illustratively, VM-based appliances.

In various embodiments, the ToR switches 131/151 and the EoR switch 141 are connected directly to the PE routers 108. In various embodiments, the core switches 110-1 and 110-2 (which also may be referred to herein as aggregation switches) are used to connect the ToR switches 131/151 and the EoR switch 141 to the PE routers 108. In various embodiments, the core switches 110-1 and 110-2 are used to interconnect the ToR switches 131/151 and the EoR switch 141. In various embodiments, direct connections may be made between some or all of the ToR switches 131/151 and the EoR switch 141.

In various embodiments, a VirtualSwitch Control Module (VCM) running in a ToR/EoR switch gathers connectivity, routing, reachability, and other control plane information from other routers and network elements inside and outside the DC 101-X. The VCM may run also on a VM located in a regular server. The VCM then programs each of the virtual switches with the specific routing information relevant to the VMs associated with that virtual switch. This programming may be performed by updating L2 or L3 forwarding tables or other data structures within the virtual switches. In this manner, traffic received at a virtual switch is propagated from a virtual switch toward an appropriate next hop over a tunnel between the source hypervisor and destination hypervisor using an IP tunnel. The ToR/EoR switch may perform tunnel forwarding without being aware of the service addressing.

It is noted that, generally speaking, the “end-users/customer edge equivalents” for the internal DC network include either VM or server blade hosts, service appliances, or storage areas. Similarly, the DC gateway devices (e.g., PE nodes 108) offer connectivity to the outside world (e.g., the Internet, VPNs (e.g., IP Virtual Private Networks (VPNs), Virtual Private Local Area Network (LAN) Services (VPLSs), Virtual Private Wire Services (VPWSs), or the like), other DC locations, enterprise private network deployments or (residential) subscriber deployments (e.g., BNG, Wireless (LTE or the like), cable, or the like, as well as various combinations thereof), or the like, as well as various combinations thereof).

In addition to the various elements and functions described above, the system 100 of FIG. 1 further includes a Management System (MS) 190. The MS 190 is adapted to support various management functions associated with one or more of the DCs 101 or, more generically, telecommunication network or computer network resources. The MS 190 is adapted to communicate with various portions of the system 100, such as one or more of the DCs 101. The MS 190 may also be adapted to communicate with other operations support systems (e.g., one or more of Element Management Systems (EMSs), Topology Management Systems (TMSs), or the like, as well as various combinations thereof).

The MS 190 may be implemented at a network node, network operations center (NOC), or any other location capable of communication with the relevant portion of the system 100, such as a specific DC 101 and various elements related thereto. The MS 190 may be implemented as a general purpose computing device or specific purpose computing device, such as described herein with respect to FIG. 11. The MS 190 may include Alcatel-Lucent Service Aware Manager (SAM) functionality.

The PE nodes 108 communicate with each other, as well as each of the ToR switches 131/151, via an L3 service such as Virtual Private Routed Network (VPRN), Virtual Routing and Switching (VRS), Internet Enhanced Service (IES), or the like. L3 services supporting communications between and among the PE nodes 108 and ToR switches 131/151 may be implemented by establishing VPRN services at each of the PE nodes 108, and distributed VRS (dVRS) services at each of the ToR switches 131/151. Thus, the L3 services are supported by the PE nodes 108, ToR switches 131/151, and various other real or virtual entities therebetween. It should be noted that while a particular L3 service is described herein, other L3 services may also be used in various embodiments.

The ToR switches 131/151 each support one or more respective virtual switches and one or more VMs. L2 services supporting communications between and among the virtual switches and VMs may be implemented by establishing an E-VPN between ToR switches 131 and 151 such that various types of communications (e.g., virtual switching, traffic propagation, or the like, as well as various combinations thereof) may be provided between the various virtual elements. In essence, the transport/switching infrastructure provided by the ToR switches 131 and 151 may be used to support the virtualized communication paths between the various virtual switches and VMs. It should be noted that while a particular L2 service is described herein, other L2 services may also be used in various embodiments.

In the exemplary architectures discussed herein, the ToR switches 131/151 or EoR switches 141 at each rack manage the servers of that rack and communicate with MS 190. The MS 190 manages the ToR switches 131/151, the EoR switches 141, the VMs instantiated within the servers, or the like, as well as various combinations thereof. The ToR switches 131/151 and EoR switches 141 also operate various services, such as L3 services (e.g., VPRN), L2 services (e.g., VPLS), or the like.

In the exemplary architectures discussed herein, each virtual server typically includes a respective instantiation of hypervisor software for instantiating and managing the various VMs of that server. The hypervisor provides management of VMs and their services for multiple customers (e.g., tenants) in a secure manner, according to various policies that define operating parameters conforming to relevant service level agreements (SLAs). A session established between a hypervisor and corresponding ToR switch 131/151 or EoR switch 141, such as an OpenFlow session, maybe used to enable appropriate instantiation and management of the various virtual switches and VMs.

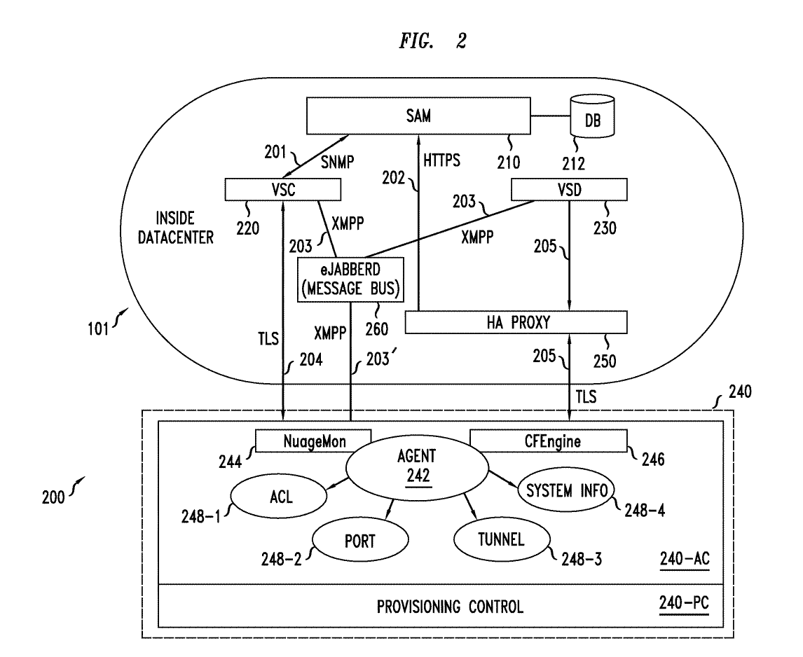

The instantiated VMs may be correlated to their physical ports on the corresponding switch (e.g., on the corresponding ToR switch 131/151 or EoR switch 141). In an exemplary topology, once a VM is provisioned, a virtual port is created. The virtual port is associated with or attached to an L2 service (e.g., VPLS), which also may be denoted herein as an eVPN service. Each L2 service (e.g., VPLS) is associated with or attached to an L3 service (e.g., VPRN), which in turn may be attached to other VPRN services. For example, assume that multiple VMs are instantiated at different servers, where each server is associated with a respective TOR switch 131/151 or EoR switch 141. Thus, at a first site (e.g., server 1), one or more VMs are associated with an L2/VPLS service. Similarly, at a second site, one or more VMs are associated with the same L2/VPLS service network, such as depicted with respect to FIG. 2. Data may be transmitted from the VMs to the PE routers, such as Alcatel-Lucent 7750 service routers, via the L2/VPLS service network and the L3/VPRN.

In various embodiments, multiple VPLS sites and multiple VPRN sites are used. A discovery process enables discovery of each of the ToR switches 131/151 and EoR switches 141 such that a database may be constructed to include various elements and entities associated with the ToR switches 131/151 and EoR switches 141 (e.g., VPLSs, VPRSs, sites, VMs, or the like, as well as various combinations thereof). This database may be used to derive various correlations among virtual and non-virtual entities.

FIG. 2 depicts a simplified representation of a Virtual Services Platform (VSP) suitable for use within the system of FIG. 1.

The VSP 200 provides DC management elements and techniques in accordance with various embodiments. Broadly speaking, DC management system entities cause local provisioning entities (e.g., within the DC) or remote provisioning entities (e.g., remote/enterprise) to instantiate virtual services, wherein the management system entity has associated with it a management database of expected instantiated virtual services, and each of the provisioning entities has associated with it a local database (e.g., OpenFlow tables) of actual instantiated virtual services. Thus, it will be appreciated that other DC management elements and techniques may also be used in accordance with the various embodiments herein. For example, other and varied communication elements, other than those described herein, may be used for the various purposes described herein. Moreover, various topologies, management entities, configurations, and so on may be used wherein some or all of the elements described herein are not implemented, are implemented in a different manner, are replaced by different functional elements, and so on.

Referring to FIG. 2, the VSP 200 includes a plurality of DC management elements, including a Service Aware Manager (SAM) 210, a Virtualized Services Controller (VSC) 220, and a Virtualized Services Directory (VSD) 230. As depicted and described herein, the various DC management elements cooperate to cause a Network Services Gateway (NSG) 240 to provision virtual services at a remote location. It will be appreciated that, in at least some embodiments, SAM 210 and NSG 240 of FIG. 2 may correspond to MS 190 and elements of a DC 101 of FIG. 1, respectively. The VSP also includes an HA Proxy 250 and an eJabberd message bus server 260.

The SAM 210 performs various management system functions within the context of a DC 101, such as described above with respect to MS 190 of FIG. 1. It is noted that, with respect to the embodiments described herein, SAM 210 (or MS 190) operates to manage various virtual and non-virtual elements within the DC 101, including managing the instantiation of virtual services and termination (or tear down) of virtual services. Accordingly, SAM 210 maintains a database 212 for storing data representing the expected configuration of the DC 101, including data representing those virtual services instantiated by each of the virtual services provisioning entities within the DC 101 (e.g., NSGs (illustratively, NSG 240), VSDs (illustratively, VSDs 230), hypervisors, or other functional elements tasked with instantiating and supporting virtual services in accordance with management commands provided via the SAM 210, MS 190, or other management entities authorized to provisioned virtual services within the DC 101).

The VSC 220 is a virtual services control entity (herein, an SDN controller) configured to program the DC network forwarding plane elements (e.g., the NSGs such as NSG 240) with appropriate networking parameters required for customer portions of a virtualized network. Generally speaking, the VSC 220 auto-discovers the various networking parameters of the VMs, virtual ports, and various services attached to the server and programs those parameters transparently and automatically. In turn, this programs them into the network fabric of the DC 101.

The VSC 220 is used to configure one or more networking elements (e.g., a Network Services Gateway (NSG) such as NSG 240, a Virtual Routing and Switching (VRS) entity or element, a Virtual Routing and Switching Gateway (VRSG) entity or element, or the like) to provision various virtual services such as VPRNs, virtual services tunnels, VMs, virtual ports, access control lists (ACLs), or the like, as well as various combinations thereof. The VSC 220 may be implemented as a VM running on a virtualized server, as a module on a non-virtualized server or other computing device, or the like, as well as various combinations thereof.

The VSC 220 is depicted as using an OpenFlow communications link 204 to communicate with various distributed networking endpoints (e.g., NSG 240, a VRS entity or element, a VRSG entity or element, or the like). It will be appreciated that, while only one networking endpoint is depicted in FIG. 2 (illustratively, the NSG 240) to simplify the discussion, VSC 220 may communicate with hundreds or thousands of such networking endpoints.

The VSC 220 serves as a control plane of the DC network, maintaining a full per-tenant view of network and service topologies. Through network APIs such as OpenFlow, the VSC 220 programs the DC network independent of DC networking hardware or network architecture.

The VSC 220 causes networking endpoints (e.g., NSG 240 or other networking endpoints such as VRS entities or elements, VRSG entities or elements, or the like, as well as various combinations thereof) to provision various virtual services. In doing so, the NSG 240 (or other networking endpoint(s)) utilizes the database of information pertaining to its local provisioned virtual services. Specifically, data pertaining to NSG provisioned virtual services is stored in OpenFlow tables at the NSG 240 (or other suitable tables at other networking endpoints such as VRS entities or elements, VRSG entities or elements, or the like, as well as various combinations thereof).

The VSD 230 is a policy and analytics module within the illustrative VSP 200 of FIG. 2. The VSD 230 gathers and programs the application networking policy information per tenant, per network slice, and for user group level, and interacts with various cloud management systems. The VSD 230 may be implemented as a VM running on a virtualized server, as a module on a non-virtualized server or other computing device, or the like.

The VSD 230 is depicted as using communication links 203 supported by an Extensible Messaging and Presence Protocol (XMPP) server (illustratively, eJabberd message bus server 260) to communicate with the VSC 220 (where the communication links 203 provide an eJabberd message bus and, thus, also may be referred to herein as eJabberd message bus 203), and using communication links 205 supported by HA Proxy 250 to communicate with the NSG 240.

In various embodiments, agents 242 instantiated at NSG 240 (or VRSs/VRSGs) monitor eJabberd message bus 203 to identify messages indicative of a subsequent provisioning command that is expected to be received by the NSG 240 (or VRSs/VRSGs) from the VSC 220, identify a subsequent provisioning command that is expected to be received by the NSG 240 (or VRSs/VRSGs) from the VSC 220, and generate an alert (e.g., a warning, an alarm, an error message, or the like) if the subsequent provisioning command is not received or is not received according to a predetermined criteria (e.g., within a predetermined time frame or according to other criteria).

For example, a command sent within DC 101 by VSC 220 to NSG 240 (or VRS/VRSG) using OpenFlow is adapted to cause provisioning of virtual services by the NSG 240. If the NSG 240 does not implement or provision the virtual services due to some failure (e.g., a failure of the VSC 220 to receive the command, a failure of the VSC 220 to properly interpret the command, a failure of a communications channel to or from the VSC 220, or some other failure), this provides an indication that there is a problem that must be addressed at the VSC 220, the NSG 240 (or VRS/VRSG), OpenFlow, or at some other element. This failure is normally identified in due course via the SAM 210; however, where many virtual provisioning commands are being transmitted, an enormous number of failures can quickly result.

Various embodiments contemplate that functions such as verifying or auditing virtual services within a DC (or even outside the DC) are correctly provisioned. Further, various embodiments contemplate implementing a verification or auditing function within a DC in a manner that does not overtax resources associated with network management systems, such as the SAM 5620 Data Center Navigator.

Virtual services to be verified/audited may include, for example, those virtual services instantiated at the NSG 240 (or VRS entities or elements, VRSG entities or elements, or the like) in response to VSC instructions from VSC 220.

It is contemplated that verification/auditing functions may be performed by high-level, mid-level, or low-level management entities. It is contemplated that verification/auditing functions may be performed by any entity that receives, from the relevant management system entity and from the relevant provisioning entity, the database elements or datasets associated with the virtual services. In various embodiments, other management system entities, such as a SAM 210, may be adapted to perform the verification methodologies described herein.

Network Customer Premises Equipment (NCPE) such as a server or other computing device may be used to implement the NSG 240 (or VRS/VRSG) as a VM running on a virtualized server or as a module on a non-virtualized server or other computing device. As depicted herein, the NSG 240 communicates with DC management elements via, illustratively, Transport Layer Security (TLS) and Secure Sockets Layer (SSL) authentication protocols supporting multiple protocol channels such as OpenFlow, XMPP, HTTPS, SNMP, and so on.

The NSG 240 is depicted in FIG. 2 in a simplified logical manner as having a provisioning control portion 240-PC and an agent container portion 240-AC.

The depicted provisioning control portion 240-PC represents the virtual and/or non-virtual processing, memory, and input/output modules configured to instantiate virtual services in response to a command received from the VSC 220 via an OpenFlow channel.

The depicted agent container portion 240-AC represents the virtual and/or non-virtual processing, memory, and input/output modules configured to instantiate one or both of a container denoted as NuageMon 244 and a container denoted as CFEngine 246.

The container denoted as NuageMon 244 is depicted as hosting an agent 242 performing various functions related to virtual services verification/auditing as described herein. The agent 242 receives a verification command pertaining to some or all of the provisioned virtual services. In response, the agent 242 retrieves data associated with the relevant provisioned virtual services from OpenFlow tables stored at NSG 240. As depicted in FIG. 2, the agent 242 retrieves OpenFlow table data pertaining to Access Control Lists (ACL) 248-1, virtual ports 248-2, virtual services tunnels 248-3, system information 248-4, or other OpenFlow table data pertaining to various virtual services, as well as various combinations thereof. The retrieved OpenFlow table data may be forwarded directly to the requesting management system entity, or normalized into a predefined dataset prior to being forwarded to the requesting management system entity.

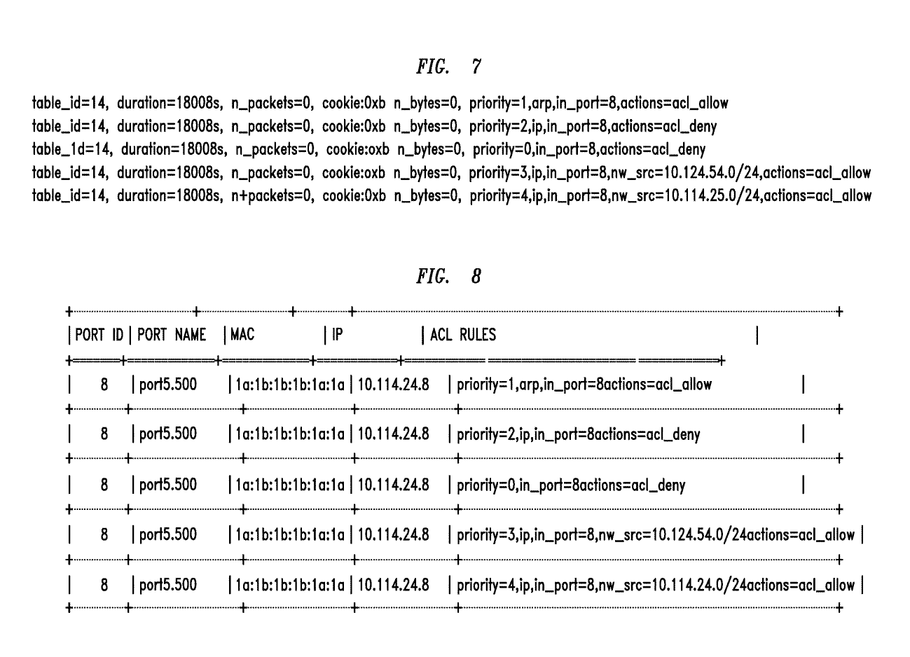

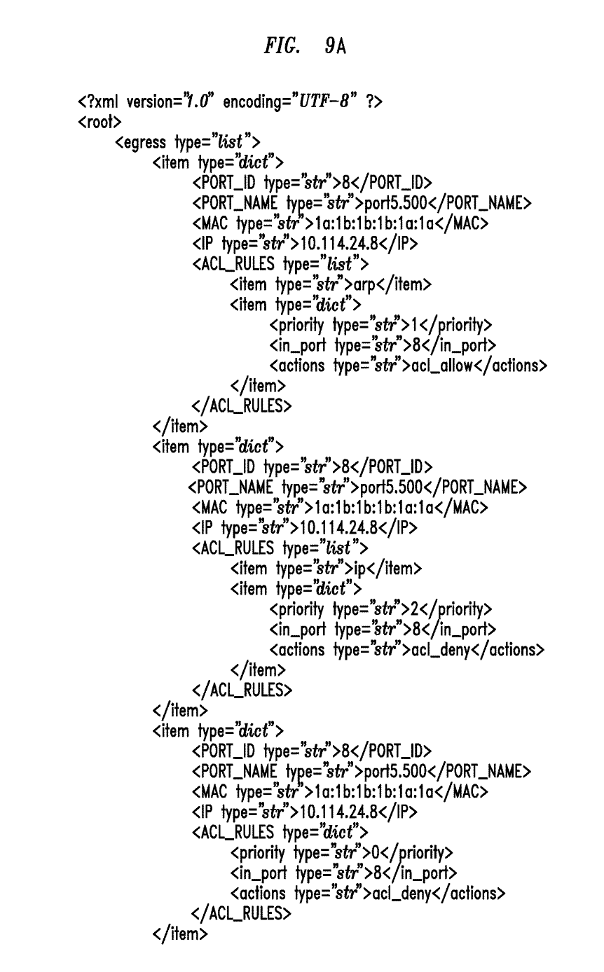

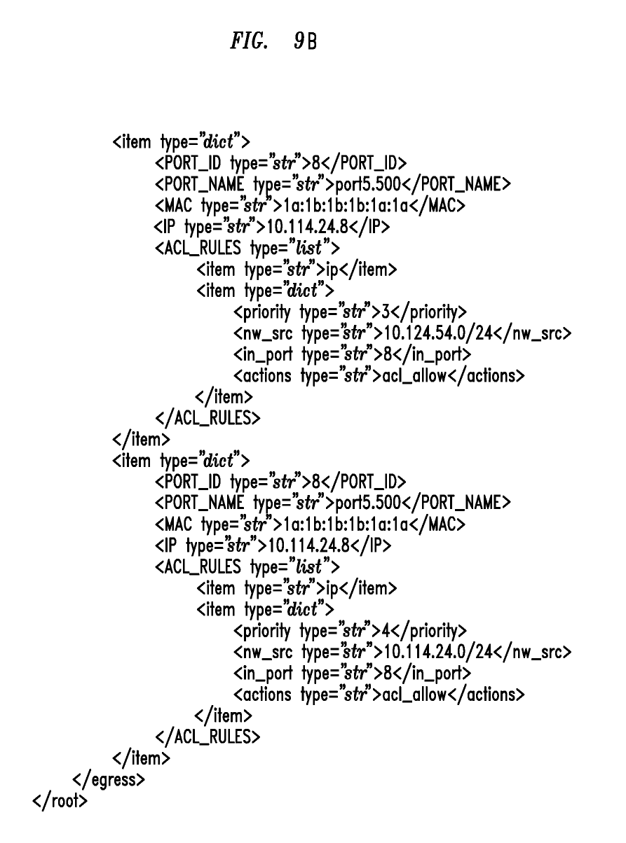

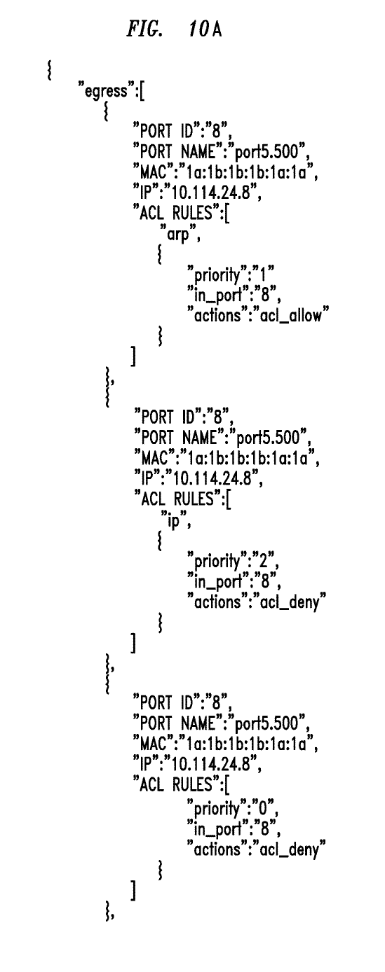

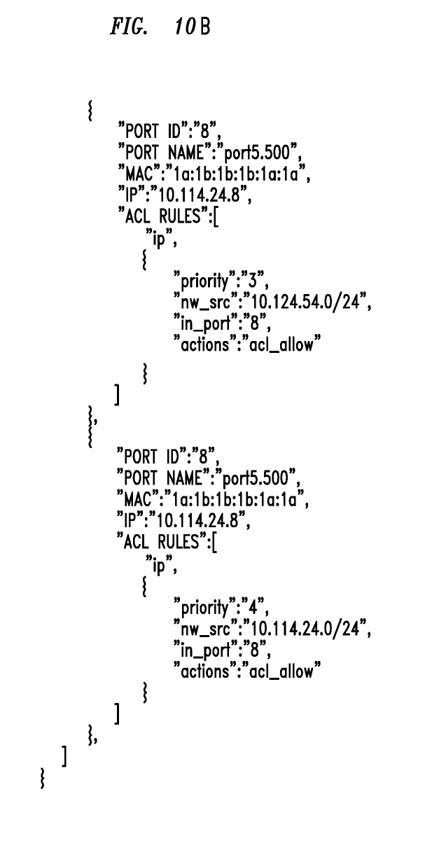

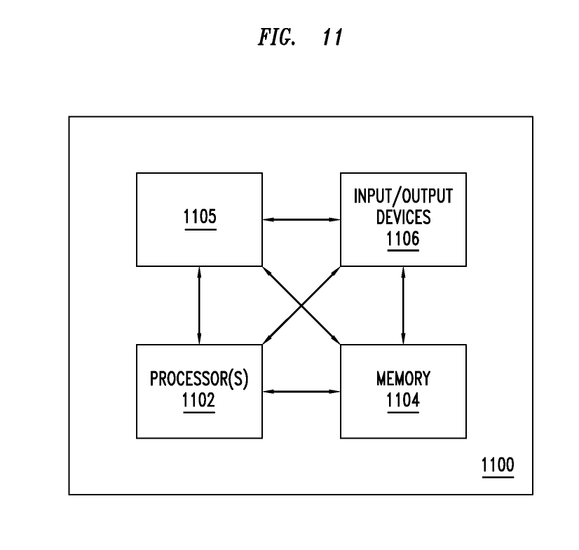

Formatting the retrieved OpenFlow table data advantageously reduces the amount of data transmitted to the requesting management system entity. Further, by formatting the retrieved OpenFlow table data in accordance with a common format, a smaller and normalized dataset may be transmitted instead of a larger amount of OpenFlow table data. Various embodiments contemplate the use of different formats, which formats may optionally be specified by the verification command. Formats may include, for example, raw format (an example of which is depicted in FIG. 7), tabulated format (an example of which is depicted in FIG. 8), Extensible Markup Language (XML) format (an example of which is depicted in FIGS. 9A and 9B), JavaScript Object Notation (JSON) format (an example of which is depicted in FIGS. 10A and 10B), or other suitable formats.

In various embodiments, the agent 242 associated with the container denoted as NuageMon 244 transmits the formatted or unformatted OpenFlow table data to a requesting management system entity (e.g., SAM 210) via a SNMP command channel supported by TLS.

In various embodiments, the agent 242 associated with the container denoted as CFEngine 246 monitors eJabberd message bus 203 to identify relevant NSG virtual services provisioning commands transmitted from the VSD 230 toward the VSC 220, determine if the identified commands were received by the NSG 240, and report back to SAM 210 (or other suitable management system entity) via HA Proxy 250. In various embodiments, this determination is made by comparing eJabberd message bus commands to received OpenFlow commands. Failure to receive the identified commands may indicate a problem associated with the VSC 220, the eJabberd message bus 203, or an OpenFlow channel 204 by which the VSC 220 provides instantiation control information to the NSG 240 (or VRS/VRSG).

In various embodiments, the agent 242 associated with the container NuageMon 244 transmits the alert (e.g., a warning, an alarm, an error message, or the like) information associated with a missing instantiation command to SAM 210 (or other suitable management system entity) via HA Proxy 250 supported by TLS.

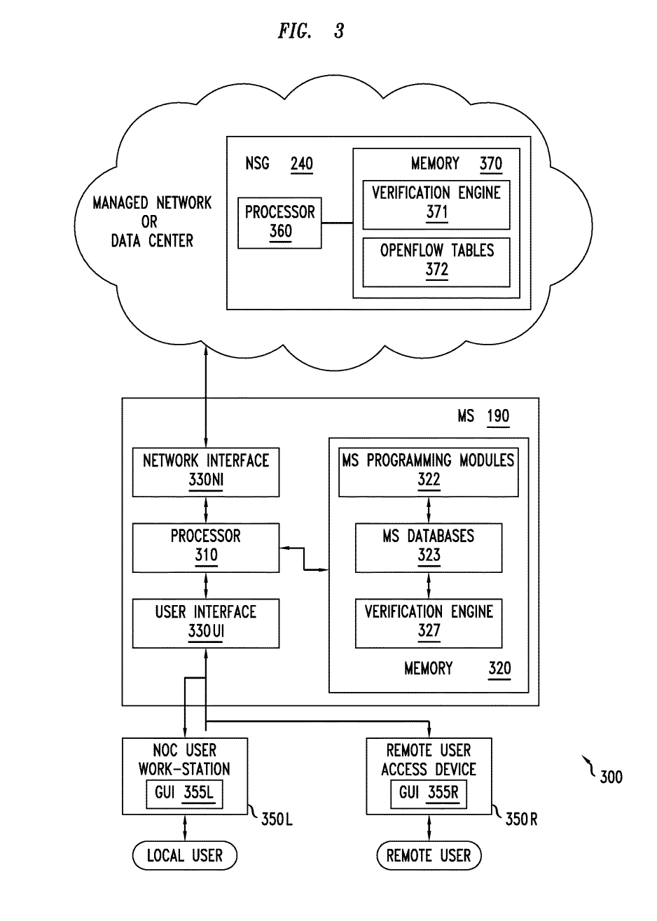

FIG. 3 depicts an exemplary management system suitable for use in the system of FIG. 1.

As depicted in FIG. 3, MS 190 is configured to provide various management functions for networking endpoints (e.g., illustratively, NSG 240 or other networking endpoints such as VRS entities or elements, VRSG entities or elements, or the like, as well as various combinations thereof).

As depicted in FIG. 3, MS 190 includes one or more processor(s) 310, a memory 320, a network interface 330N, an optional user interface 3301, and support circuits 340. The processor(s) 310 is coupled to each of the memory 320, the network interface 330N, and the user interface 3301.

The processor(s) 310 is adapted to cooperate with the memory 320, the network interface 330N, the user interface 3301, and the support circuits 340 to provide various management functions for a DC 101 or the system 100 of FIG. 1.

The memory 320, generally speaking, stores programs, data, tools, and the like that are adapted for use in providing various management functions for the DC 101 and various associated elements of system 100 of FIG. 1.

The memory 320 includes various management system (MS) programming modules 322 and MS databases 323 adapted to implement network management functionality, such as discovering and maintaining network topology, correlating various elements and sub-elements, monitoring/processing virtual element related requests (e.g., instantiating, destroying, migrating, and so on), and the like.

The MS programming modules 322 may adapt the operation of the MS 190 to manage various network elements, DC elements, and the like, such as described above with respect to FIGS. 1-2, as well as various other network elements (not shown) or various communication links therebetween. The MS programming modules 322 may be implemented using software instructions which may be executed by a processor (e.g., processor(s) 310) for performing the various management functions depicted and described herein. The MS programming modules 322 may also implement various service aware manager (SAM) functions or network manager functions.

The MS databases 323 are used to store topology data, network element data, service related data, VM related data, protocol related data, and any other data related to the operation of MS 190. The MS databases 323 may be used to store DC topology information, tenant information, information defining instantiated services, or the like, as well as various combinations thereof.

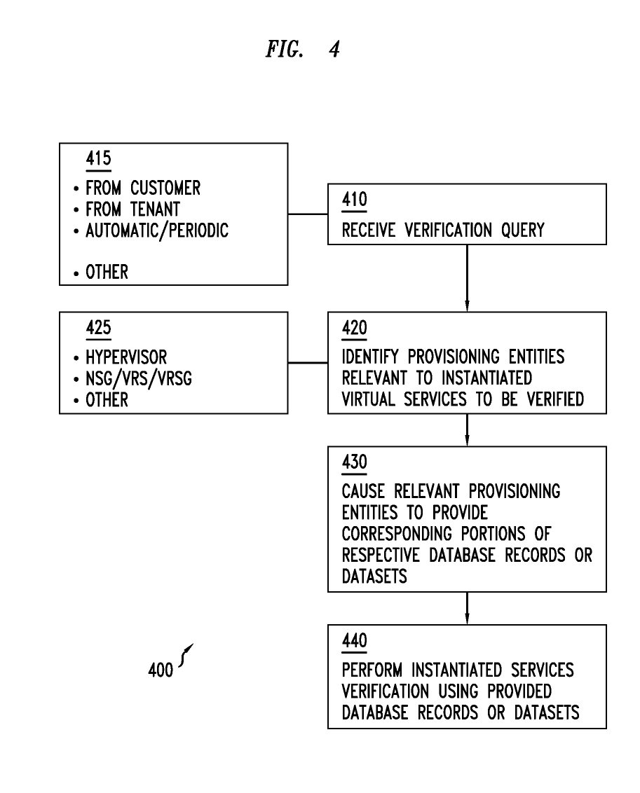

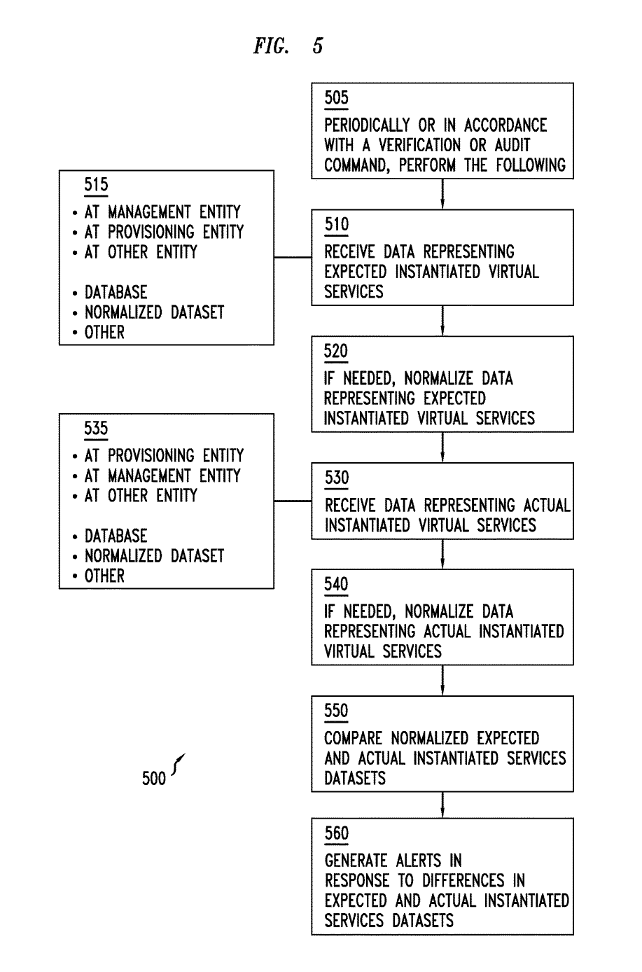

The memory 320 also may include a verification engine (VE) 327 operable to verify that those virtual services expected to have been instantiated by one or more provisioning entities within the DC 101 have in fact been instantiated. Thus, various embodiments of the VE 327 may perform functions such as those depicted and described with respect to FIG. 4 and FIG. 5. The VE 327 of MS 190 also may be configured to perform, or at least support (e.g., via coordination with NSG 240 (or other networking endpoints such as VRS entities or elements, VRSG entities or elements, or the like, as well as various combinations thereof), various other verification functions depicted and described herein. While depicted as a separate entity, the VE 327 may be implemented within the context of the MS programming modules 322 or other functional elements/engines described herein.

The network interface 330N is adapted to facilitate communications with various network elements, nodes, and other entities within the DC 101, system 100, or other network to support the management functions performed by MS 190.

The user interface 3301 is adapted to facilitate communications with one or more user workstations (illustratively, user workstation 350), for enabling one or more users to perform management functions for the DC 101, system 100, or other network.

Various implementations providing functionality, such as the MS programming modules 322, MS databases 323, or VE 327, may be provided without providing any user interface functionality as appropriate.

The functionality described herein with respect to the MS 190 of FIG. 3 may be adapted to implement one or more elements of VSP 200 of FIG. 2 (e.g., SAM 210 of FIG. 2).

As depicted in FIG. 3, provisioning entities (e.g., illustratively, NSG 240, or other networking endpoints such as VRS entities or elements, VRSG entities or elements, or the like, as well as various combinations thereof) may be managed by MS 190.

The NSG 240 includes a processor 360 and a memory 370. The memory 370 includes a verification engine (VE) 371 and OpenFlow tables 372.

The VE 371 may be configured to process provisioning information associated with various instantiated services to verify that such services are correctly instantiated. The VE 371 may be configured to process provisioning information associated with various instantiated services to verify that such services are correctly instantiated by comparing virtual services provisioning information stored at a high level management system entity (e.g., MS 190, SAM 210, eJabberd message bus server 260, or the like) to virtual services provisioning information stored at one or more provisioning entities (e.g., NSG 240 or other networking endpoints such as VRS entities or elements, VRSG entities or elements, or the like, as well as various combinations thereof). Thus, various embodiments of VE 371 may perform, or at least support, functions such as those depicted and described herein with respect to FIG. 4 and FIG. 5.

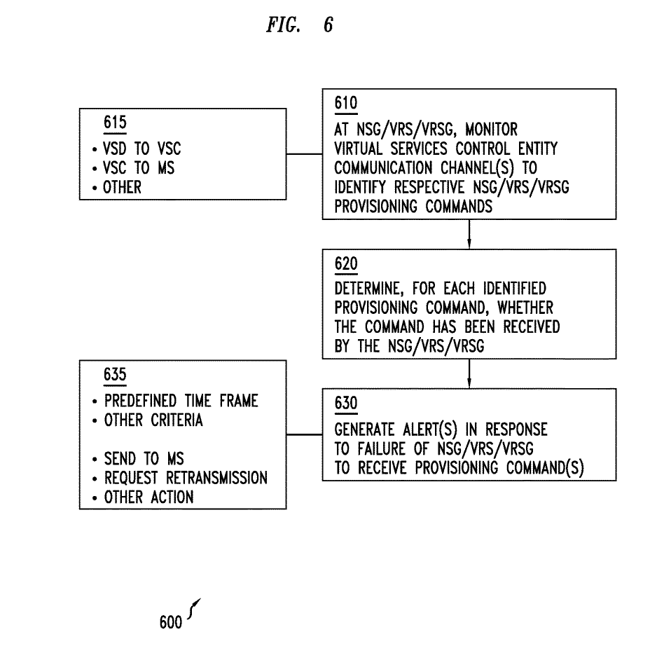

The VE 371 may be configured to verify that those virtual services expected to have been instantiated by one or more provisioning elements within the DC 101 have in fact been instantiated. Thus, various embodiments of VE 371 may perform, or at least support, functions such as those depicted and described herein with respect to FIG. 6.

In at least some embodiments, MS programming modules 322, MS databases 323, VE 327, and/or VE 371 may cooperate to provide various functions depicted and described herein. Although primarily depicted and described herein with respect to specific functions being performed by using specific ones of the engines or databases of memory 320 and/or memory 370, it will be appreciated that any of the management functions depicted and described herein may be performed by using any one or more of the engines or databases of memory 320 and/or memory 370.

FIG. 4 depicts a flow diagram of an instantiated services verification method according to various embodiments.

Specifically, FIG. 4 depicts a flow diagram of a method 400 of verifying that the virtual services expected by a management system entity (e.g., SAM 210, MS 190, or the like) to have been instantiated by a provisioning entity (e.g., NSG/VRS/VRSG) have, in fact, been instantiated as indicated by the local database of the provisioning entity.

At step 410, a verification query is received by a verification engine. Referring to box 415, the verification engine may be implemented at a provisioning entity (e.g., NSG 240, a VRS, a VRSG, or the like), a management entity (e.g., MS 190, SAM 210, or the like), or any other suitable entity or element. Referring to box 415, the verification query may be provided to the verification engine via various sources (e.g., a customer, a tenant, or other source), may be generated automatically or periodically (e.g., in response to periodically receiving database entries or datasets of a provisioning entity, such as NSG 240, a VRS, a VRSG, or the like), or the like, as well as various combinations thereof.

At step 420, the provisioning entities relevant to the instantiated virtual services to be verified are identified. Referring to box 425, the relevant provisioning entities may include any suitable provisioning entities which may store data indicative of the actual state of instantiated virtual services to be verified (e.g., a hypervisor, an NSG/VRS/VRSG, or any other suitable provisioning entity storing data indicative of the actual state of the instantiated network services to be verified).

At step 430, the relevant provisioning entities provide corresponding portions of respective database records or datasets. For example, to verify the instantiated virtual services associated with a particular NSG/VRS/VRSG, a command is transmitted toward the particular NSG/VRS/VRSG indicating the instantiated virtual services to be verified so that the corresponding data (e.g., OpenFlow table data) local to that NSG/VRS/VRSG may be retrieved by the NSG/VRS/VRSG, normalized if necessary to a predefined or requested format, and transmitted toward the requesting entity.

At step 440, an instantiated services verification is performed using the provided database records or datasets. For example, to verify some or all of the instantiated services associated with a particular NSG/VRS/VRSG (e.g., NSG 240), the management system entity (e.g., MS 190, SAM 210, or the like may request that the particular NSG/VRS/VRSG (e.g., NSG 240) return a normalized dataset (e.g., such as a tabular format, an XML format, a JSON format, or the like) corresponding to the instantiated virtual services of interest. The management system entity (e.g., MS 190, SAM 210, or the like then compares this applied instantiated services dataset to an expected instantiated services dataset to verify that the expected instantiated services have in fact been instantiated at the NSG/VRS/VRSG. The applied instantiated services dataset may include a portion of a provisioning entity database of the provisioning entity that is processed in accordance with a predefined normalizing format (e.g., tabular, XML, JSON, or the like). The expected instantiated services dataset may include a corresponding portion of a management database of the management system entity that is processed in accordance with the predefined normalizing format (e.g., tabular, XML, JSON, or the like).

FIG. 5 depicts a flow diagram of an instantiated services verification method according to various embodiments.

Specifically, FIG. 5 depicts a flow diagram of a method 500 of verifying that the virtual services expected by a management system entity to have been instantiated by a provisioning entity (e.g., NSG/VRS/VRSG) have, in fact, been instantiated as indicated by the local database of the provisioning entity.

As indicated by step 505, the various steps of method 500 of FIG. 5 may be performed periodically or in accordance with a verification or audit command.

At step 510, data representing expected instantiated virtual services is received. As indicated by box 515, the data representing expected instantiated virtual services may be received at a management system entity (e.g., SAM 210, MS 190, or the like), at a provisioning entity (e.g., NSG/VRS/VRSG), or at any other suitable entity which may perform instantiated services verification. As indicated by box 515, the data representing expected instantiated virtual services may be from a database, may be a normalized dataset, or the like. It is noted that, although omitted from FIG. 5 for purposes of clarity, the entity performing instantiated services verification also may received data including expected services information for use in performing instantiated services verification (e.g., information from a message bus, such as the eJabberd message bus server 260 of FIG. 2).

At step 520, if necessary or desirable, the data representing expected instantiated virtual services may be normalized. The data representing expected instantiated virtual services may be normalized in accordance with the predefined normalizing format (e.g., tabular, XML, JSON, or the like).

At step 530, data representing actual instantiated virtual services is received. As indicated by box 535, the data representing actual instantiated virtual services may be received at a provisioning entity (e.g., NSG/VRS/VRSG), a management system entity (e.g., SAM 210, MS 190, or the like), or at any other suitable entity which may perform instantiated services verification. As indicated by box 535, the data representing actual instantiated virtual services may be from a database, may be a normalized dataset, or the like.

At step 540, if necessary or desirable, the data representing actual instantiated virtual services may be normalized. The data representing actual instantiated virtual services may be normalized in accordance with the predefined normalizing format (e.g., tabular, XML, JSON, or the like).

At step 550, the normalized data representing expected instantiated virtual services and the normalized data representing actual instantiated virtual services is compared to identify differences therebetween.

At step 560, one or more alerts is generated in response to identified differences between the normalized data representing expected instantiated virtual services and the normalized data representing actual instantiated virtual services.

FIG. 6 depicts a flow diagram of an instantiated command delivery verification method according to various embodiments.

At step 610, virtual services control entity communication channels are monitored, at a provisioning entity (e.g., NSG/VRS/VRSG), to identify respective provisioning commands intended for the provisioning entity. As indicated by box 615, the provisioning commands may include provisioning commands sent from a VSD to a VSC, from a VSC to an MS (e.g., in the form of SNMP notifications or other suitable types of notifications), or the like, as well as various combinations thereof. The virtual services control entity may be an SDN controller (e.g., a VSC as depicted and described herein) or any other suitable virtual services control entity.

At step 620, for each identified provisioning command intended for the provisioning entity, a determination is made as to whether the provisioning command has been received by the provisioning entity.

At step 630, one or more alerts is generated in response to a determination that one or more provisioning commands intended for the provisioning entity were not received by the provisioning entity. As indicated by box 635, the one or more alerts may be generated in response to a determination that one or more provisioning commands intended for the provisioning entity were not received by the provisioning entity according to a predetermined criteria (e.g., within a predetermined time frame or according to other criteria). As indicated by box 635, the one or more alerts may be sent to a management system entity, may be configured to request retransmission of the one or more provisioning commands intended for the provisioning entity that were not received by the provisioning entity, or the like, as well as various combinations thereof.

Various embodiments are directed to rapidly and proactively identifying failed instantiations of virtual services (e.g., virtual networks, VMs, virtual ports, access control lists, virtual services tunnels, or the like) due to a failure of a provisioning entity to receive one or more provisioning/instantiation commands.

A Virtualized Services Controller (VSC) causes an entity (e.g., a Network Services Gateway (NSG), a VRS entity, a VRSG entity, or the like) to provision various virtual services such as Virtual Private Routed Networks (VPRNs), virtual services tunnels, VMs, virtual ports, access control lists (ACLs), and so on. The VSC receives messages from a VSD via a communications channel or bus, and it is noted that agents instantiated at various entities (e.g., NSGs, VRSs, VRSGs, or the like) monitor that bus to identify messages indicative of subsequent provisioning commands that are expected to be received from the VSC and generate an alert (e.g., a warning, an alarm, an error message, or the like) or other suitable type of notification, or take any other suitable action, if the subsequent provisioning commands are not received according to a predetermined criteria (e.g., within a predetermined time frame or according to other criteria).

For example, a command sent within a DC by a VSC to a NSG using OpenFlow is adapted to cause provisioning of virtual services by the NSG. If the NSG does not implement or provision the virtual services due to a failure to receive the command then there is a problem that must be addressed at one or more entities (e.g., the VSC, the NSG, Open Flow, one or more other entities, or the like, as well as various combinations thereof). This failure is normally identified in due course via the management system (e.g., by SAM, such as by a SAM CPAM); however, where many virtual provisioning commands are being transmitted, an enormous number of failures can quickly result.

An agent at the NSG, VRS, or VRSG monitors the channel/bus (e.g., eJabberd) used by a VSD to communicate with the VSC such that the commands to be instantiated at the agent are then expected by the agent within some relatively small time frame. If the commands are not received in that time frame then the NSG or VRSG invokes a corresponding “failure to receive command” alert (or other types of alerts, such as a warning, an alarm, an error message, or the like) so that the reason behind the failure (e.g., OpenFlow failure or other failure) may be quickly determined before additional similar failures occur.

For example, each NSG/VRS/VRSG agent monitors VSD to VSC communication channels/buses (e.g., eJabberd) to identify virtual service provisioning or configuration information associated with the respective NSG/VRS/VRSG. In response to identifying relevant information, the agent will store the relevant information in anticipation of the VSC causing the NSG/VRS/VRSG to implement the identified provisioning or configuration. If the identified provisioning or configuration is not received (and, thus, not implemented) according to a predetermined criteria (e.g., within a predetermined time frame or according to other criteria), the NSG/VRS/VRSG agent may generate an alert (e.g., a warning, an alarm, an error message, or the like) indicating such. In this manner, VSC commands that have failed to reach the NSG/VRS/VRSG according to predetermined criteria may be proactively identified and corrected.

Various embodiments focus on specific types of messages monitored, specific buses monitored, types of instantiated virtual services, timing pertaining to determining whether an alarm should be generated, profile delivery of agent monitoring/response behaviors, and so on.

Various embodiments contemplate normalizing database elements, OpenFlow table data, and so on into a common dataset format to reduce the amount of data to be transmitted, to provide a common processing format for comparison purposes, and so on.

An example of the various formats and the advantage of using such formats is provided using an example of retrieving ACL instantiation data from a database (e.g., an OpenFlow table) of a provisioning entity (e.g., NSG/VRS/VRSG). In various embodiments, the retrieved ACL instantiation data may be formatted to reduce its size and provide a common or normalized data structure for subsequent processing. The process of normalizing the data may be performed at the management system entity (e.g., where the management system entity is performing verification), may be performed at the provisioning entity (e.g., where the provisioning entity is performing verification, to avoid transmitting excess data from the provisioning entity to the requesting management system entity where the management system entity is performing verification, or the like), or may be performed at both the provisioning entity and the management system entity.

The following example assumes that a request to verify ACL data for port 8 has been received. A command propagated to the NSG to perform this task may be of the following form:

*A:SDN>tools>vswitch# command “ovs-appctl bridge/dump-flows alubr0”

It is noted that, in this example, there are only five ACL rules in table_id 14 with priority 0 to 4. As such, even though the raw data returned by the NSG in response to such a command may comprise hundreds of lines of plaintext, only five lines of plaintext are of interest. The five lines of plaintext of interest from the raw data are shown in FIG. 7. Thus, it will be appreciated that processing the raw data or plaintext values to at least remove plaintext lines that are not of interest provides an initial reduction in the amount of raw data to be further handled (e.g., to be further processed by the NSG, to be transmitted by the NSG to the SAM, or the like). However, to further reduce the amount of data to be handled and, in particular, to normalize the data format, various embodiments process the raw data to provide a normalized representation of the data (e.g., using one or more of a tabular format, an XML format, a JSON format, or the like, as well as various combinations thereof). A command propagated to the NSG to perform this task may be of the following form:

*A:NSG>tools>vswitch# command “show acl-n port5.500”

As noted above, the normalized representation of the raw data may be represented in various formats. An exemplary representation of the raw data of FIG. 7 in tabular format is depicted in FIG. 8. An exemplary representation of the raw data of FIG. 7 in XML format is depicted in FIGS. 9A and 9B. An exemplary representation of the raw data of FIG. 7 in JSON format is depicted in FIGS. 10A and 10B. It will be appreciated that other formats may be used.

It is noted that, although primarily depicted and described herein with respect to embodiments in which services verification functions are provided for specific types of services (namely, virtual services, which also may be referred to as virtualized services), various embodiments of the services verification functions depicted and described herein may be used or adapted for use in providing services verification for various other types of services (e.g., other types of network services other than virtual services, other types of services, or the like, as well as various combinations thereof).

FIG. 11 depicts a high-level block diagram of a computing device, such as a processor in a telecom network element, suitable for use in performing functions described herein such as those associated with the various elements described herein with respect to the figures.

In particular, one or more management, network, communication, or resource allocating elements, such as management entities, provisioning entities, and other entities or elements as described herein, may be implemented in accordance with the computing device structure of FIG. 11, as well as structure of FIG. 3 and other structures described herein.

As depicted in FIG. 11, computing device 1100 includes a processor element 1102 (e.g., a central processing unit (CPU) or other suitable processor(s)), a memory 1104 (e.g., random access memory (RAM), read only memory (ROM), and the like), a cooperating module/process 1105, and various input/output devices 1106 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in hardware or in a combination of software and hardware, e.g., using a general purpose computer, one or more application specific integrated circuits (ASIC), or any other hardware equivalents. In one embodiment, the cooperating process 1105 can be loaded into memory 1104 and executed by processor 1102 to implement the functions as discussed herein. Thus, cooperating process 1105 (including associated data structures) can be stored on a computer readable storage medium, e.g., RAM memory, magnetic or optical drive or diskette, and the like.

It will be appreciated that computing device 1100 depicted in FIG. 11 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

Various modifications may be made to the systems, methods, apparatuses, mechanisms, techniques, and portions thereof described herein with respect to the various figures, such modifications being contemplated as being within the scope of embodiments disclosed herein. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications, and the like.

Although various embodiments which incorporate the teachings of the present disclosure have been shown and described in detail herein, those skilled in the art can readily devise many other varied embodiments that still incorporate these teachings. Thus, while the foregoing is directed to various embodiments of the present disclosure, other and further embodiments may be devised without departing from the basic scope thereof. As such, the appropriate scope of various embodiments is to be determined according to the claims.

What is claimed is:

1. A method of verifying instantiated services associated with a data center, comprising:
comparing, by a network element associated with the data center, an applied instantiated services dataset associated with a provisioning entity to an expected instantiated services dataset associated with the provisioning entity to identify any differences therebetween; and
storing, in a non-transient memory at the network element, data representing identified differences between the datasets associated with the provisioning entity;
wherein said applied instantiated services dataset comprises a portion of a provisioning entity database processed in accordance with a predefined normalizing format; and
wherein said expected instantiated services dataset comprises a corresponding portion of a management database processed in accordance with the predefined normalizing format.

2. The method of claim 1, wherein the network element associated with the data center comprises a management system (MS) entity, the method further comprising:
receiving, from the provisioning entity, provisioning entity database information associated with the provisioning entity; and
processing the provisioning entity database information associated with the provisioning entity to provide, for the provisioning entity, the applied instantiated services dataset.

3. The method of claim 2, further comprising:
transmitting, toward the provisioning entity, a verification request command adapted to cause the provisioning entity to transmit requested database information toward the MS entity.

4. The method of claim 3, wherein said verification request command identifies at least a portion of the provisioning entity database information in accordance with one or more of a virtual service identifier, a customer identifier, a resource identifier, a provisioning command identifier, or a time period of interest.

5. The method of claim 1, wherein the network element associated with the data center comprises a management system (MS) entity, the method further comprising:
receiving, from the management database, management entity database information associated with the provisioning entity; and
processing the management entity database information associated with the provisioning entity to provide, for the provisioning entity, the expected instantiated services dataset.

6. The method of claim 1, wherein the network element associated with the data center includes the provisioning entity, the method further comprising:
obtaining, from the provisioning entity database, provisioning entity database information associated with the provisioning entity; and
processing the provisioning entity database information associated with the provisioning entity to provide, for the provisioning entity, the applied instantiated services dataset.

7. The method of claim 1, wherein the network element associated with the data center includes the provisioning entity, the method further comprising:
receiving, from a management system (MS) entity, MS entity database information associated with the provisioning entity; and
processing the MS entity database information associated with the provisioning entity to provide, for the provisioning entity, the expected instantiated services dataset.

8. The method of claim 7, further comprising:
transmitting, toward the MS entity, a verification request command adapted to cause the MS entity to provide requested database information.

9. The method of claim 8, wherein said verification request command identifies at least a portion of the MS entity database information in accordance with one or more of a virtual service identifier, a customer identifier, a resource identifier, a provisioning command identifier, or a time period of interest.

10. The method of claim 1, wherein the network element associated with the data center includes the provisioning entity, the method further comprising:
monitoring one or more communication channels of a virtual services control entity to identify a provisioning command intended for the provisioning entity;
determining, for the identified provisioning command intended for the provisioning entity, whether the identified provisioning command intended for the provisioning entity has been received by the provisioning entity according to a predetermined criteria; and
generating an alert based on a determination that the identified provisioning command intended for the provisioning entity has not been received by the provisioning entity according to the predetermined criteria.

11. The method of claim 10, wherein the predetermined criteria comprises a predetermined time frame.

12. An apparatus for verifying instantiated services associated with a data center, the apparatus comprising:
a processor and a memory communicatively connected to the processor, the processor configured to:
compare, by a network element associated with the data center, an applied instantiated services dataset associated with a provisioning entity to an expected instantiated services dataset associated with the provisioning entity to identify any differences therebetween; and
store, in a non-transient memory at the network element, data representing identified differences between the datasets associated with the provisioning entity;
wherein said applied instantiated services dataset comprises a portion of a provisioning entity database processed in accordance with a predefined normalizing format; and
wherein said expected instantiated services dataset comprises a corresponding portion of a management database processed in accordance with the predefined normalizing format.

13. The apparatus of claim 12, wherein the network element associated with the data center comprises a management system (MS) entity, the processor further configured to:
receive, from the provisioning entity, provisioning entity database information associated with the provisioning entity; and
process the provisioning entity database information associated with the provisioning entity to provide, for the provisioning entity, the applied instantiated services dataset.

14. The apparatus of claim 13, the processor further configured to:
transmit, toward the provisioning entity, a verification request command adapted to cause the provisioning entity to transmit requested database information toward the MS entity.

15. The apparatus of claim 14, wherein said verification request command identifies at least a portion of the provisioning entity database information in accordance with one or more of a virtual service identifier, a customer identifier, a resource identifier, a provisioning command identifier, or a time period of interest.

16. The apparatus of claim 12, wherein the network element associated with the data center comprises a management system (MS) entity, the processor further configured to:
receive, from the management database, management entity database information associated with the provisioning entity; and
process the management entity database information associated with the provisioning entity to provide, for the provisioning entity, the expected instantiated services dataset.

17. The apparatus of claim 12, wherein the network element associated with the data center includes the provisioning entity, the processor further configured to:
obtain, from the provisioning entity database, provisioning entity database information associated with the provisioning entity; and
process the provisioning entity database information associated with the provisioning entity to provide, for the provisioning entity, the applied instantiated services dataset.

18. The apparatus of claim 12, wherein the network element associated with the data center includes the provisioning entity, the processor further configured to:
receive, from a management system (MS) entity, MS entity database information associated with the provisioning entity; and
process the MS entity database information associated with the provisioning entity to provide, for the provisioning entity, the expected instantiated services dataset.

19. The apparatus of claim 18, the processor further configured to:
transmit, toward the MS entity, a verification request command adapted to cause the MS entity to provide requested database information.

20. The apparatus of claim 19, wherein said verification request command identifies at least a portion of the MS entity database information in accordance with one or more of a virtual service identifier, a customer identifier, a resource identifier, a provisioning command identifier, or a time period of interest.

21. The apparatus of claim 12, wherein the network element associated with the data center includes the provisioning entity, the processor further configured to:
monitor one or more communication channels of a virtual services control entity to identify a provisioning command intended for the provisioning entity;
determine, for the identified provisioning command intended for the provisioning entity, whether the identified provisioning command intended for the provisioning entity has been received by the provisioning entity according to a predetermined criteria; and
generate an alert based on a determination that the identified provisioning command intended for the provisioning entity has not been received by the provisioning entity according to the predetermined criteria.

22. The apparatus of claim 21, wherein the predetermined criteria comprises a predetermined time frame.

23. A non-transitory computer-readable storage medium storing instructions which, when executed by a computer, adapt the operation of the computer to perform a method of verifying instantiated services associated with a data center, the method comprising:
comparing, by a network element associated with the data center, an applied instantiated services dataset associated with a provisioning entity to an expected instantiated services dataset associated with the provisioning entity to identify any differences therebetween; and
storing, in a non-transient memory at the network element, data representing identified differences between the datasets associated with the provisioning entity;
wherein the applied instantiated services dataset comprises a portion of a provisioning entity database processed in accordance with a predefined normalizing format; and
wherein the expected instantiated services dataset comprises a corresponding portion of a management database processed in accordance with the predefined normalizing format.
